(19) United States
(12) Patent Application Publication
(10) Pub. No.: US 2008/0252771 A1
(43) Pub. Date: Oct. 16, 2008

(54) CAMERA MODULE WITH COMPACT PACKAGING OF IMAGE SENSOR CHIP AND METHOD OF MANUFACTURING THE SAME

(75) Inventor: YING-CHENG WU, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/871,923

(22) Filed: Oct. 12, 2007

(30) Foreign Application Priority Data
Apr. 13, 2007 (CN) 200710200456.2

(51) Int. Cl. H04N 5/225

(52) U.S. Cl. 348/340; 348/E05.024; 348/E05.025; 348/E05.026; 348/E05.027; 348/E05.028; 348/E05.029; 348/E05.03

(57) ABSTRACT

An exemplary camera module includes a lens module, a base, an image sensor chip, a bonding layer, and an imaging lens. The lens module is disposed on the base. The lens module is optically aligned with the image sensor chip. The image sensor chip is disposed on the base. The image sensor chip includes a photosensitive area. The bonding layer is disposed on at least one of the image sensor chip and the base. The bonding pads surround the photosensitive area. The imaging lens is adhered onto the bonding layer and hermetically seals the photosensitive area. The imaging lens is configured for focusing light signals onto the photosensitive area. The present invention also relates to a method for manufacturing the camera module.

### CROSS-REFERENCE TO RELATED APPLICATION

This application is related to a copending U.S. patent application entitled “COMPACT IMAGE SENSOR PACKAGE AND METHOD OF MANUFACTURING THE SAME” with the same assignee. The disclosure of the above-identified application is incorporated herein by reference.

### TECHNICAL FIELD

The present invention relates to camera modules and, particularly, to a camera module having a compact packaging of image sensor chip and a relatively high image quality, and a method for manufacturing the camera module.

### BACKGROUND

With the ongoing development of micro-circuitry and multimedia technology, digital cameras have now entered widespread use. High-end portable electronic devices, such as mobile phones and PDAs (Personal Digital Assistants), are being developed to be increasingly multi-functional. Many of these portable electronic devices are equipped with digital cameras. A key component of the digital cameras is a camera module. To facilitate portability, the camera module tends to be compact, slim, and light.

FIG. 8 illustrates a typical camera module 100. The camera module 100 includes a lens module 10, a transparent cover 18, and an image sensor chip 15. The lens holder 10 is a hollow chamber. The lens module 10 includes a lens barrel 12, a lens holder 14, and a lens assembly 16 received in the lens barrel 12. The lens barrel 12 is partially received in and is threadingly engaged with the lens holder 14. The image sensor chip 15 is typically attached onto/upon a base 13. The image sensor chip 15 has a photosensitive area 151 formed thereon. The base 13 includes a substrate 131 and a plurality of frames 132 around the image sensor chip 15. The transparent cover 18 is disposed on the frames 132 using an adhesive 17. The lens module 10 is mounted onto the transparent cover 18 using the adhesive 17. The transparent cover 18 and the base 13 cooperatively form a sealed chip cavity 133. The image sensor chip 15 is received in the sealed chip cavity 133.

However, the chip cavity 133 is likely to be larger than the image sensor chip 15 because of height of the frames 132 and length of the wires 123. Therefore, the dimensions of packaging of the image sensor chip 15 are not efficiently reduced. Furthermore, due to the over-sized chip cavity 133, the photosensitive area 151 may easily become contaminated by dust and so on. This impacts image quality of the camera module 100.

What is needed, therefore, is a camera module that has a compact structure and a relatively high image quality.

What is needed, also, is a method for manufacturing the camera module.

### SUMMARY

In accordance with an embodiment, a camera module includes a lens module, a base, an image sensor chip, a bonding layer, and an imaging lens. The lens module is disposed on the base. The lens module is optically aligned with the image sensor chip. The image sensor chip is disposed on the base. The image sensor chip includes a photosensitive area. The bonding layer is disposed on at least one of the image sensor chip and the base. The bonding pads surround the photosensitive area. The imaging lens is adhered onto the bonding layer and hermetically seals the photosensitive area. The imaging lens is configured for focusing light signals onto the photosensitive area.

Other advantages and novel features will be drawn from the following detailed description of at least one present embodiment, when considered in conjunction with the attached drawings.

### BRIEF DESCRIPTION OF THE DRAWINGS

Many aspects of the present camera module and manufacturing method thereof can be better understood with reference to the following drawings. The components in the drawings are not necessarily drawn to scale, the emphasis instead being placed upon clearly illustrating the principles of the present camera module. Moreover, in the drawings, like reference numerals designate corresponding parts throughout the several views.

FIG. 1 is a schematic, cross-sectional view of a camera module, according to a first present embodiment.

FIG. 2 is a flow chart of a method for manufacturing the camera module of FIG. 1.

FIG. 3 is a schematic, cross-sectional view of a camera module, according to a second present embodiment.

FIG. 4 is a schematic, cross-sectional view of a camera module, according to a third present embodiment.

FIG. 5 is a schematic, cross-sectional view of a camera module, according to a fourth present embodiment.

FIG. 6 is a schematic, cross-sectional view of a camera module, according to a fifth present embodiment.

FIG. 7 is a schematic, cross-sectional view of a camera module, according to a sixth present embodiment.

FIG. 8 is a schematic, cross-sectional view of a conventional camera module.

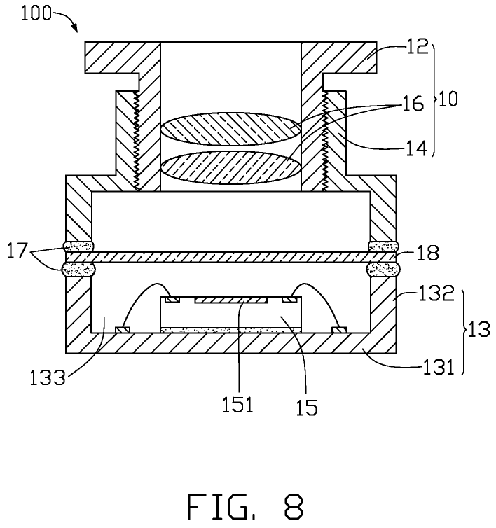

### DETAILED DESCRIPTION OF PREFERRED EMBODIMENTS

Embodiments of the present camera module and manufacturing method thereof will now be described in detail below and with reference to the drawings.

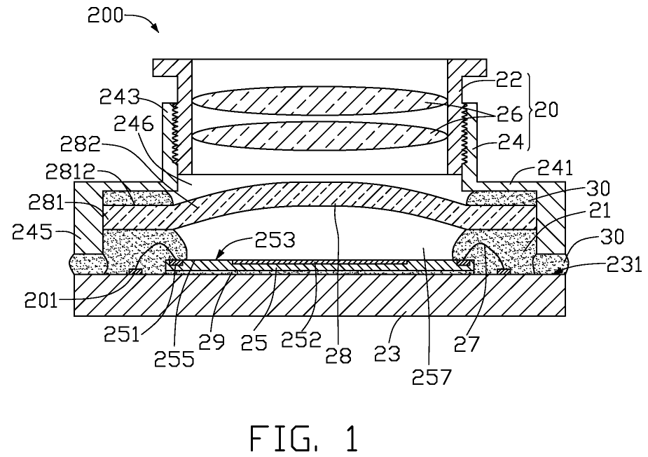

FIG. 1 illustrates a camera module 200, in accordance with a first present embodiment. The camera module 200 includes a lens module 20, a bonding layer 21, a base 23, an image sensor chip 25, and an imaging lens 28.

The image sensor chip 25 is disposed on the base 23. The lens module 20 is disposed on the base 23 and receives the image sensor chip 25 and the image lens 28 therein. The bonding layer 21 is disposed on at least one of the image sensor chip 25 and the base 23. The imaging lens 28 is fixed on the bonding layer 21. The lens module 20 is optically aligned with the image sensor chip 25.

The lens module 20 usefully includes a lens holder 24, a lens barrel 22, and a lens assembly 26. The lens barrel 22 is a hollow cylinder configured for receiving the lens assembly 26 therein. The lens barrel 22 is threadingly engaged with the lens holder 24. In the illustrated embodiment, the lens assembly 26 includes two lenses. In other embodiments, the lens assembly 26 could include one, three or more lenses received in the lens barrel 22.

The lens holder 24 has a shoulder portion 241, a front end 243, and a rear end 245. The front end 243 and the rear end 245 extend from two opposite ends of the shoulder portion 241 along two opposing directions of an axis of the lens holder 24, respectively. The front end 243 and the rear end 245 each are, advantageously, perpendicular to the shoulder portion 241. The shoulder portion 241, the front end 243, and the rear end 245 cooperatively define a receiving cavity 246 penetrating/extending through the lens holder 24 from the front end 243 to the rear end 245.

The base 23 is, advantageously, a printed circuit board. The base 23 has a top surface 231. A plurality of base pads 201 is disposed on the top surface 231 of the base 23 and surrounds the image sensor chip 25. The base 23 is, beneficially, made of a material selected from the group consisting of: polyester, polyimide, ceramic, and glass fiber.

The image sensor chip 25 is, advantageously, a charged coupled device (CCD), or a complementary metal-oxide-semiconductor transistor (CMOS). The image sensor chip 25 is able to convert the received light signals into digital electrical signals.

The image sensor chip 25 could, advantageously, be adhered onto the top surface 231 of the base 23, e.g., via an adhesive layer 29. The image sensor chip 25 is, beneficially, optically aligned with the lens module 20 (e.g., the lens assembly 26). For example, an optical axis of the lens module 20 is aligned with that of the image sensor chip 25. The image sensor chip 25 is, usefully, received in an inner side of the receiving cavity 246 adjacent to the rear end 245. The adhesive layer 29 is, usefully, an anisotropic conductive paste (ACP) or an anisotropic conductive film (ACF). Alternatively, the adhesive layer 29 could be replaced by any other appropriate fixing means such as, for example, metallurgical means.

The image sensor chip 25 has an upper surface 253 facing the imaging lens 28. The image sensor chip 25 includes a photosensitive (i.e., active) area 252 disposed on the upper surface 253 and a non-photosensitive area 255 around the photosensitive area 252. The photosensitive area 252 is configured (i.e., structured and arranged) for receiving light signals transmitted through the imaging lens 28.

A plurality of chip pads 251 is disposed on the non-photosensitive area 255 of the image sensor chip 25 and surrounds the photosensitive area 252. Each chip pad 251 is electrically connected to a corresponding base pad 201, e.g., via a respective wire 27. The wires 27 are, advantageously, made of a conductive material, such as gold, silver, aluminum, or an alloy thereof.

The bonding layer 21 is, advantageously, made of an adhesive material, for example, a silicone, epoxy, acrylic, or polyamide adhesive. The bonding layer 21 advantageously covers at least one of the chip pads 251 and the base pads 201. In the illustrated embodiment, the bonding layer 21 covers the chip pad 251, the base pads 201, and the wires 27, in order to protect the wires 27 from metal fatigue, ensure the connections between the ends of the wires 27 and the two pads 221, 201, and to adequately insulate the individual wires 27 to help avoid potential shorting.

Alternatively, the bonding layer 21 could be applied to a peripheral edge of the top surface 231 of the base 23 and be apart from the base pads 201. Alternatively, the bonding layer 21 could be applied to the non-photosensitive area 255 and be interposed between the photosensitive area 252 and the chip pads 251.

The imaging lens 28 hermetically seals the photosensitive area 252 together with the bonding layer 21 and is configured for forming an imaging light signal onto the photosensitive area 252. The imaging lens 28 is, beneficially, selected from the group consisting of: an aspheric lens, a spherical lens, and a converging lens. The imaging lens 28 includes a centric optical portion 282 and a peripheral non-optical portion 281 around the optical portion 282. The optical portion 282 is, advantageously, a vaulted structure and is spaced from the photosensitive area 252 at a predetermined distance. The predetermined distance substantially depends on a height of the vaulted optical portion 282 with respect to the photosensitive area 252.

The imaging lens 28 is, advantageously, received in the receiving cavity 246 adjacent to the rear end 245. The imaging lens 28 is, beneficially, in contact with an inner wall of the rear end 245. The non-optical portion 281 has a top face 2812 and a lower face 2811 facing away from each other. The lower face 2811 is adhered onto the bonding layer 21. The imaging lens 28 is, usefully, attached to the shoulder portion 241, e.g., via an adhesive 30. The rear end 245 could be adhered onto the base 23, with e.g., the adhesive 30.

The imaging lens 28 and the bonding layer 21 cooperatively form a protective package around the photosensitive area 252, thereby defining an interspace 257. The distance between the vaulted optical portion 281 and the upper surface 253 is kept to a minimum, thus, volume of the interspace 257 is relatively small. Therefore, the photosensitive area 252 has little risk of being contaminated by dust and the like. As such, the camera module 200 has an enhanced reliability and a relatively high image quality.

On one hand, the imaging lens 28 is fixed on the image sensor chip 25 via the bonding layer 21. Accordingly, height of packaging of the image sensor chip 25 is reduced.

On the other hand, the imaging lens 28 functions as a cover configured for protecting the photosensitive area 252 and an imaging member configured for focusing a light signal onto the photosensitive area 252. That is, the imaging lens 28 and the lens assembly 26 cooperatively form a lens system (e.g., an imaging system). Actually, the imaging lens 28 is fixed on the image sensor chip 25, but not in the lens barrel 22. Thus, if the number of lenses to be used in the lens system is fixed, the lens holder 20 can be correspondingly reduced in size compared with a conventional holder where all of the lenses are fixed in the lens barrel. As a result, total size of the camera module 200 is reduced, thereby achieving a compact camera module 200.

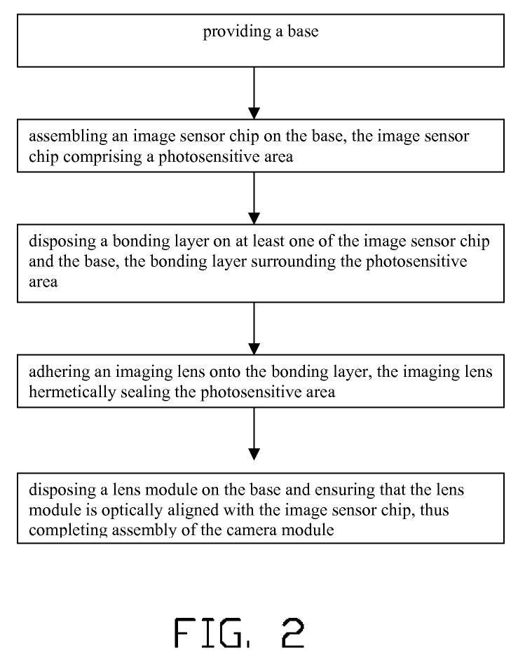

FIG. 2 illustrates a method for manufacturing the camera module 200. The method includes the steps as follows. Providing a base 23. Assembling an image sensor chip 25 on the base 23, the image sensor chip 25 including a photosensitive area 252. Disposing a bonding layer 21 on at least one of the image sensor chip 25 and the base 23, the bonding layer 21 surrounding the photosensitive area 252. Adhering an imaging lens 28 onto the bonding layer 21, the imaging lens 28 hermetically sealing the photosensitive area 252. Disposing a lens module 20 on the base 23 and ensuring that the lens module is optically aligned with the image sensor chip. As such, assembly of the camera module 200 is completed.

The image sensor chip 25 could, beneficially, be adhered onto the base 23, e.g. via an adhesive layer 29. Each base pad 201 is electrically connected to one respective chip pad 251 via a corresponding wire 27. The image sensor chip 25 is, usefully, assembled on the base 23, by a packaging process, for example, a chip-scale packaging process, a wafer-level chip-scale packaging process, a ceramic leaded packaging process, a plastic leadless chip packaging process, a thermal compression bonding process, or a flip chip packaging process.

The bonding layer 21 could, advantageously, be made of an adhesive material, for example, a silicone, epoxy, acrylic, or polyamide adhesive. The adhesive material is disposed on the image sensor chip 25, by using, for example, an adhesive dispenser. The adhesive material is, advantageously, applied to cover the chip pads 251, the base pads 201, and the wires 27. The adhesive material extends from an edge of the upper surface 253 of the image sensor 22 to a corresponding edge of the top surface 231 of the base 23.

The imaging lens 28 is, usefully, fixed on the image sensor chip 25 by adhering the non-optical portion 281 onto the bonding layer 21. The imaging lens 28 is, advantageously, adjusted by, for example, sliding the non-optical portion 281 on the bonding layer 21, in order to ensure that an optical axis of the optical portion 282 is aligned with an optical axis of the photosensitive area 252. Then, the adhesive material is solidified by, e.g., ultraviolet radiation or heating. Thus, the imaging lens 28, the image sensor chip 25, and the base 23 are integrated with each other via the bonding layer 21.

The lens module 20 can be preassembled, e.g., by the following steps. Assembling the lens assembly 26 in the lens barrel 22, e.g., using glue. The lens barrel 22 is threadingly engaged with the lens holder 24. An adhesive material is applied onto the top face 2812 of the image lens 28. Another adhesive material is applied onto the top surface 231 of the base 23. Then, the rear end 245 of the lens holder 24 is disposed on the adhesive material applied onto the base 23 and the shoulder portion 241 is disposed on the adhesive material applied onto the image lens 28. After solidifying, the lens module 20 is fixed on the base 23. Accordingly, the desired assembly of camera module 200 is completed.

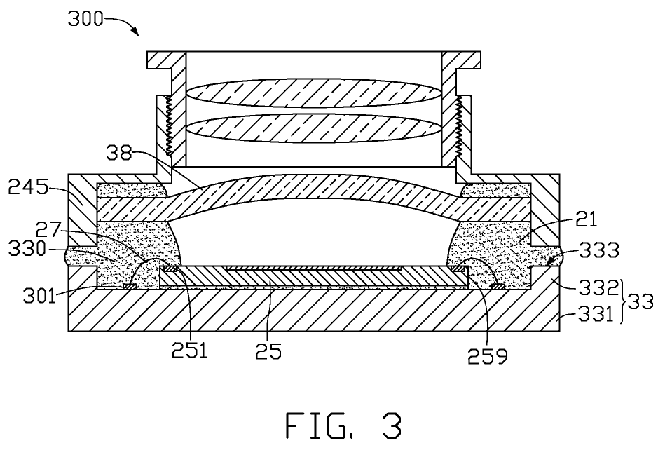

FIG. 3 illustrates a camera module 300 in accordance with a second present embodiment. The camera module 300 is essentially similar to the camera module 200, except for the base 33.

In this embodiment, the base 33 includes a substrate 331 and a plurality of protectors 332. A plurality of base pads 301 is disposed on the substrate 331. Each protector 332 has an upper face 333. The protectors 332 advantageously protrude out of peripheral edges of the substrate 331 along a direction substantially perpendicular to the substrate 331. The protectors 332 usefully have a height, substantially equal to a height of the image sensor chip 35. The rear end 245 is, advantageously, adhered onto the protectors 332 via the bonding layer 21.

The protectors 332 are, beneficially, spaced from and parallel to respective sidewalls 259 of the image sensor chip 35. Thus, an interspace 330 is defined between the protectors 332 and the sidewalls 259. The interspace 3830 is filled, advantageously, until brimming over with material of the bonding layer 21. The bonding layer 21 usefully covers the base pads 301 of the base 33, the upper faces 333 of the projectors 332, the chip pads 251 of the image sensor chip 25, and the wires 27 electrically connecting the two pads 251 and 301.

The manufacturing method of the camera module 300 is essentially similar to the manufacturing method of the camera module 200 in the first present embodiment, except for the additional formation of the projectors 332 on the substrate 331. The projectors 332 are, advantageously, co-molded with the substrate 331, thereby obtaining the base 33. Alternatively, the projectors 332 could be formed on edges of the substrate 331 via, e.g., an adhesive or a solder.

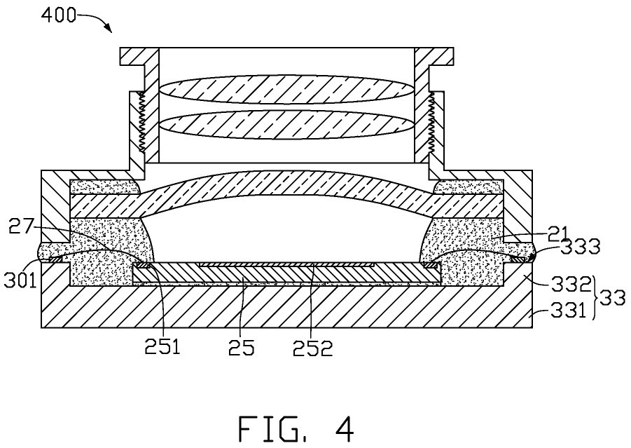

FIG. 4 illustrates a camera module 400, in accordance with a third present embodiment. The camera module 400 is essentially similar to the camera module 300 in the second embodiment, except for the base pads 301. In this embodiment, the base pads 301 are disposed on the upper faces 333 of the projectors 332, accordingly facilitating the formation of an electrical connection between the two pads 251, 301. The bonding layer 21 advantageously covers the chip pads 251, the wires 27, and the base pads 301 on the upper face 33.

The manufacturing method of the camera module 400 is essentially similar to the manufacturing method of the camera module 300 in the second present embodiment, except for the formation of the base pads 301. The base pads 301 are formed on the upper face 333 of the projectors 332. The chip pads 251 are electrically connected to the base pads 301 with wires 27, e.g., using a ball stitch on ball (BSOB) technique and wire bonding equipment.

Around the upper face 333 of the projectors 332, sufficient free space can be provided for operating the wire bonding equipment, thereby improving bonding reliability of the wires 27. Otherwise, distance between each sidewall 259 of the image sensor chip 25 and one respective projector 332 can be reduced, accordingly minimizing the camera module 400.

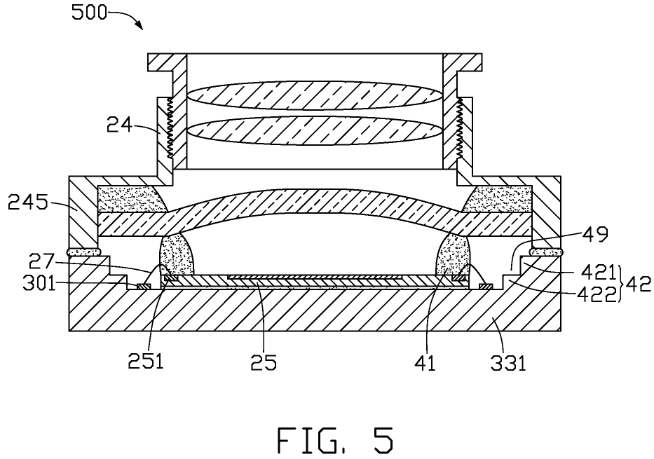

FIG. 5 illustrates a camera module 500, in accordance with a fourth present embodiment. The camera module 500 is essentially similar to the camera module 300 in the second embodiment, except for the projectors 42 and the bonding layer 41. In this embodiment, each projector 42 includes a top portion 421 and a step portion 422. The top portion 421 is configured for supporting the rear end 245 of the lens holder 24. The step portion 422 is lower than top portion 421 but a little higher than the substrate 331, thereby forming a stepped-shape interspace 49 around the base pads 301. The interspace 49 can provide sufficient free space for operation of the wire bonding equipment, thereby improving bonding reliability of the wires 27. The bonding layer 41 is disposed on the image sensor chip 25 and covers the chip pads 251 and parts of the wires 27.

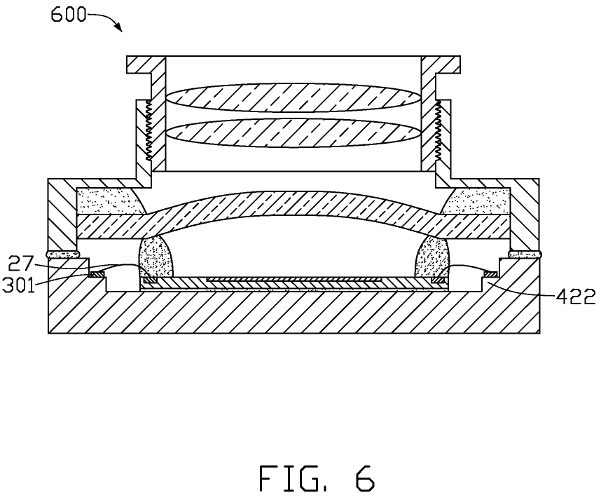

FIG. 6 illustrates a camera module 600, in accordance with a fifth present embodiment. The camera module 600 is essentially similar to the camera module 500 in the fourth embodiment, except for the base pads 301. In this embodiment, each base pad 301 is disposed on the step portion 422 of the projector 42.

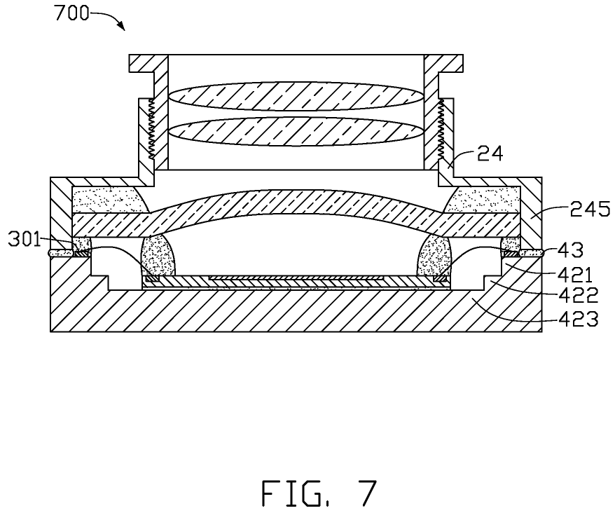

FIG. 7 illustrates a camera module 700, in accordance with a sixth present embodiment. The camera module 700 is essentially similar to the camera module 500 in the fourth embodiment, except for the base pads 301. In this embodiment, each base pad 301 is disposed on the top portion 421 of the projector 42. An adhesive 43 is applied on the top portion 421 of the projector 42. The rear end 245 of the lens holder 24 is adhered onto the adhesive 43 and surrounds the base pads 301.

The three kinds of camera modules 500, 600, 700 could, e.g., be made, using the same method as the manufacturing method of the camera module 400.

It will be understood that the above particular embodiments and methods are shown and described by way of illustration only. The principles and features of the present invention may be employed in various and numerous embodiments thereof without departing from the scope of the invention as claimed. The above-described embodiments illustrate the scope of the invention but do not restrict the scope of the invention.

What is claimed is:

1. A camera module comprising:
a base;
an image sensor chip disposed on the base, the image sensor chip comprising a photosensitive area;
a lens module disposed on the base, the lens module being optically aligned with the image sensor chip;
a bonding layer disposed on at least one of the image sensor chip and the base, the bonding layer surrounding the photosensitive area; and
an imaging lens adhered onto the bonding layer, the imaging lens hermetically sealing the photosensitive area together with the bonding layer and being configured for focusing light signals onto the photosensitive area.

2. The camera module as claimed in claim 1, wherein the imaging lens and the bonding layer cooperatively form a sealed interspace above the photosensitive area.

3. The camera module as claimed in claim 1, wherein the base comprises a substrate and a plurality of projectors protruding out of edges of the substrate along a direction substantially parallel to an optical axis of the imaging lens.

4. The camera module as claimed in claim 3, wherein the projectors are apart from and surround the image sensor chip, accordingly defining an interspace therebetween, the bonding layer being inserted to a point where the interspace is brimming over with material of the bonding layer.

5. The camera module as claimed in claim 3, wherein the image sensor chip comprises a plurality of chip pads disposed around the photosensitive area, the substrate comprises a plurality of base pads interposed between the image sensor chip and the projectors, each base pad being electrically connected to a respective chip pad via a wire.

6. The camera module as claimed in claim 5, wherein each of the projectors comprises a top portion configured to support the holder thereon and a step portion lower than the top portion but higher than the substrate to thereby form a stepped-shape interspace around the base pad for facilitating bonding the wire to the base pad.

7. The camera module as claimed in claim 5, wherein the bonding layer covers at least one of the chip pads and the base pads.

8. The camera module as claimed in claim 5, wherein the bonding layer covers the chip pads, the base pads, and the wires.

9. The camera module as claimed in claim 3, wherein a plurality of chip pads is disposed around the photosensitive area of the image sensor chip, a plurality of base pads being disposed on the projectors and corresponding to the plurality of chip pads, each base pad being electrically connected to a respective chip pad via a respective wire.

10. The camera module as claimed in claim 9, wherein the bonding layer covers the chip pads, the base pads, and the wires so as to integrate the base, the image sensor chip, and the imaging lens into a whole.

11. The camera module as claimed in claim 3, wherein each projector has a height substantially equal to the height of the image sensor chip with respect to the substrate.

12. The camera module as claimed in claim 1, wherein the imaging lens comprises a centric optical portion and a peripheral non-optical portion, the optical portion being a vaulted structure and being spaced from the photosensitive area at a predetermined distance.

13. The camera module as claimed in claim 12, wherein the non-optical portion of the imaging lens is adhered onto the bonding layer.

14. The camera module as claimed in claim 3, wherein each of the projectors comprises a top portion configured to support the holder thereon and a step portion lower than the top portion but higher than the substrate to thereby form a stepped-shape interspace around the step portion for facilitating operation of the wire bonding equipment.

15. The camera module as claimed in claim 14, wherein a plurality of chip pads is disposed around the photosensitive area of the image sensor chip, a plurality of base pads is disposed on the step portions of the projectors and corresponding to the plurality of chip pads, each base pad being electrically connected to a respective chip pad via a respective wire.

16. The camera module as claimed in claim 14, wherein a plurality of chip pads is disposed around the photosensitive area of the image sensor chip, a plurality of base pads is disposed on the top portions of the projectors and corresponding to the plurality of chip pads, each base pad being electrically connected to a respective chip pad via a respective wire.

17. A method of manufacturing a camera module, the method comprising steps of:
providing a base;
assembling an image sensor chip on the base, the image sensor chip comprising a photosensitive area;
disposing a bonding layer on at least one of the image sensor chip and the base, the bonding layer surrounding the photosensitive area;
adhering an imaging lens onto the bonding layer, the imaging lens hermetically sealing the photosensitive area; and
disposing a lens module on the base with the lens module optically aligned with the image sensor chip.

18. The method as claimed in claim 17, wherein the assembling of the image sensor chip on the base is performed by a packaging process selected from the group consisting of: a chip-scale packaging process, a wafer-level chip-scale packaging process, a ceramic leaded packaging process, a plastic leadless chip packaging process, a thermal compression bonding process, and a flip chip packaging process.

19. The method as claimed in claim 17, wherein the base comprises a substrate and a plurality of projectors protruding out of edges of the substrate along a direction substantially perpendicular to the substrate.

20. The method as claimed in claim 19, wherein the projectors are co-molded with the substrate.
